(19) United States
(12) Patent Application Publication
(10) Pub. No.: US 2014/0083410 A1
(43) Pub. Date: Mar. 27, 2014

(54) COMPONENT FOR AN APPLIANCE, ARRANGEMENT WITH A COMPONENT OF THIS TYPE AND APPLIANCE WITH A CORRESPONDING ARRANGEMENT

(71) Applicants: Ivanko Bandov, Traunreut (DE); Traunreut Bandov, Traunreut (DE); Markus Schmidt, Vachendorf (DE)

(72) Inventors: Ivanko Bandov, Traunreut (DE); Traunreut Bandov, Traunreut (DE); Markus Schmidt, Vachendorf (DE)

(73) Assignee: BSH BOSCH UND SIEMENS HAUSGERÄTE GMBH, Munich (DE)

(21) Appl. No.: 14/117,654

(22) PCT Filed: May 25, 2012
(86) PCT No.: PCT/EP2012/059803

§ 371 Date: Nov. 14, 2013

(30) Foreign Application Priority Data
May 31, 2011 (DE) 10 2011 076 832.7

(51) Int. Cl. F16B 35/00; F24C 15/08

(52) U.S. Cl. CPC F16B 35/002; F24C 15/08
USPC 126/273 R; 411/386

(57) ABSTRACT

A component for a household appliance includes a thin-walled sub-element having a connecting region configured for connection to at least one further component part. The connecting region has a funnel-shaped receptacle which is configured at least as a dual receptacle with at least two adjacent separate holes for passage of a connecting element. The dual receptacle has for each of the holes a funnel-shaped entrance.

The invention relates to a component for a household appliance, which has a thin-walled sub-element having a connecting region configured for connection to a further component part, in which connecting region a hole is configured for the passage of a connecting element, and the hole is configured in a funnel-shaped receptacle. The invention also relates to an arrangement with a component of this type and a household appliance, in particular for preparing food, with a corresponding arrangement.

A connection between thin-walled parts of a household appliance is known from DE 196 07 687 B4. Each of the connected parts has a hole, the holes being disposed in a cone-shaped indentation. The indentation in the hole in the lowest part of the composite is enclosed at least partially by an outward structure, which runs in a direction counter to the direction of the indentation. The parts are connected by way of a sheet metal screw.

When components are screwed in place, relatively high tolerances of several millimeters can occur in respect of their position as a result of processes due to their shape and position in a household appliance. Connection by way of screws is therefore often very complex during assembly. Joining and screw insertion specifically can pose problems.

The object of the present invention is to create a component and an arrangement having a component of this type as well as a household appliance with an arrangement of this type, each allowing more assembly-friendly connection.

This object is achieved by a component, arrangement and household appliance according to the independent claims.

An inventive component for a household appliance comprises a thin-walled sub-element, which has a connecting region configured for connection to at least one further component part, in which connecting region a hole is configured for the passage of a connecting element. The hole is configured in a funnel-shaped receptacle for the connecting element. One essential concept of the invention is that the receptacle is configured at least as a dual receptacle with at least two adjacent separate holes and each hole comprises a funnel-shaped entrance for the connecting element. Such an embodiment allows even relatively high position tolerances to be achieved easily for components to be connected during assembly. Specifically the connecting of the component to a further component part can take place in a very assembly-friendly manner, as the connecting element can be inserted into the dual receptacle in a simple manner and insertion into at least one of the two holes is always achieved due to the arrangement with two separate holes disposed adjacent to one another. This embodiment of the dual receptacle therefore creates a redundant arrangement of holes in a quite specific manner and in particular also creates funnel-shaped entries, allowing insertion of the connecting element in an accurate and reliable manner even if there are large tolerances between the component and the component part. Thus at least two holes are provided by way of the dual receptacle, it then being immaterial in respect of the connection of the component to the component part, which of said holes the connecting element ultimately engages in to establish the connection.

An apparatus for connecting a component to a component part is thus created, said parts having a variable position tolerance due to variable manufacturing tolerances.

Provision is preferably made for an entrance to be configured as a threaded entrance. This already creates a certain guidance for the connecting element, in particular when a screw is provided for this purpose.

A separating web is preferably provided between the holes. This arrangement allows the holes, which are configured adjacent to one another, to be delimited from one another in a defined manner. This separating web also serves to stabilize the dual receptacle in a mechanical manner in the region of said holes. Larger mechanical forces, which occur during connection of the component to the component part, can therefore also be easily compensated for.

Provision is preferably made for the separating web to be configured in a straight line. This can particularly advantageously initiate the mechanical stability of the embodiment.

Provision is preferably made for the separating web to be configured with an upper edge at a height level configured below the height level of an upper face of the receptacle. This edge is therefore configured as lowered in a downward direction in respect of the height level of the upper face of the receptacle so that during connection and direct positioning of the component on the component part it does not project and does not have an interfering effect therewith.

Provision is preferably made for the separating web to form a symmetry position of the dual receptacle. This symmetrical embodiment of the dual receptacle with holes is advantageous in that the connecting element is inserted into one of the two holes in any manner, thereby establishing a connection. As it is immaterial in this respect which of the holes the connecting element engages in, this symmetrical embodiment allows very fast and accurate assembly to be achieved when inserting the connecting element.

Provision is preferably made for the two entrances to be separated by the separating web. The separating web can thus form a certain delimiting segment for the two entrances, with the separating web forming a corresponding delimitation for both entrances.

The component is in particular configured as a single piece and is for example a correspondingly shaped sheet metal part.

Provision is preferably made for at least one hole to be configured with its main axis inclined at an angle to a vertical axis of the dual receptacle, in particular to be configured or disposed at an angle between 15° and 50°, in particular between 20° and 40°.

Provision is preferably made for both holes to be configured with their main axes at an angle to the vertical axis, with in particular a first hole being configured as inclined with a positive angle value and a second hole being configured as inclined with the negative angle thereto to the vertical axis. This further favors the abovementioned advantages.

Provision is preferably made for center points of the holes to be at a distance corresponding to double the diameter of a connecting element, in particular a screw, to be inserted into a hole. Provision is preferably made for center points of the holes to be at a distance of between 3.5 mm and 5 mm, in particular between 3.8 mm and 4.7 mm. Such an embodiment in particular allows compensation for a relatively large tolerance range of +/−4 mm in respect of the position tolerances of the parts to be connected, specifically the component and the component part, and an easy and assembly-friendly connection to be created.

The holes can be configured in an ellipse shape.

Provision is preferably made for the component to be configured as an angled foot, which has a support part and the thin-walled sub-element adjacent thereto, said thin-walled sub-element extending in the manner of a plate in a direction at an angle to the support part as a free end of the component. This provides in particular for the direct positioning of further component parts to be connected to the component on the thin-walled sub-element. The inclination of said thin-walled sub-element in relation to the support part allows the greatest possible contact surface to be achieved between the component in the connecting region and the at least one further component part.

The upper face of the thin-walled sub-element is preferably configured as flat, to favor the abovementioned full-surface contact with the further component parts to be connected.

The invention further relates to an arrangement for a household appliance, wherein the arrangement has an inventive component or an advantageous embodiment thereof. The arrangement further comprises a further separate component part of the household appliance, which is connected to the component by way of a connecting element, which is disposed in the dual receptacle and only extends through one hole.

One advantageous embodiment of the arrangement is based on the component part being a baffle wall of a household appliance configured as an oven, the baffle wall being screwed to the component. In particular the component part represents a baffle wall, which is disposed on one side of a muffle rear wall and is screwed to the component disposed on the opposite side of the muffle rear wall.

In principle all the part connections of a household appliance that are subject to position tolerances can be configured correspondingly.

The connecting element is in particular a sheet metal screw, preferably a self-tapping sheet metal screw.

The invention further relates to a household appliance, in particular a household appliance for preparing food, in particular an oven, which has an inventive arrangement and an inventive embodiment thereof.

Further features of the invention will emerge from the claims, figures and description of the figures. The features and feature combinations cited above in the description and the features and feature combinations cited below in the description of the figures and/or simply shown in the figures can be used not only in the respectively cited combination but also in other combinations or alone, without departing from the scope of the invention.

One exemplary embodiment of the invention is described in more detail below based on schematic drawings, in which:

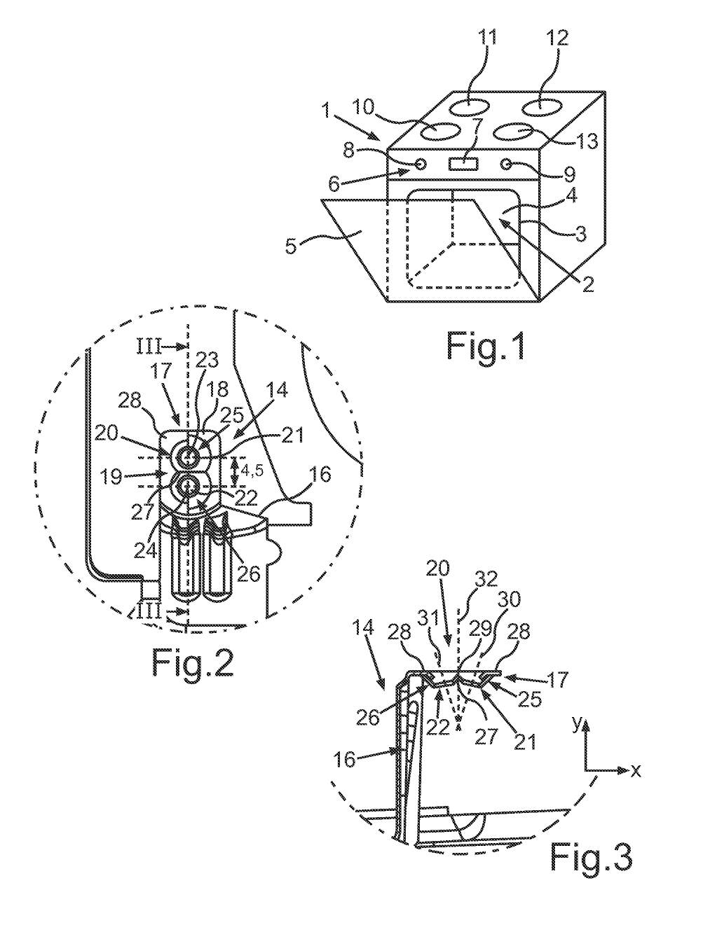

FIG. 1 shows a perspective view of an exemplary embodiment of an inventive household appliance;

FIG. 2 shows a plan view of an exemplary embodiment of an inventive component;

FIG. 3 shows a sectional view through the component according to FIG. 2;

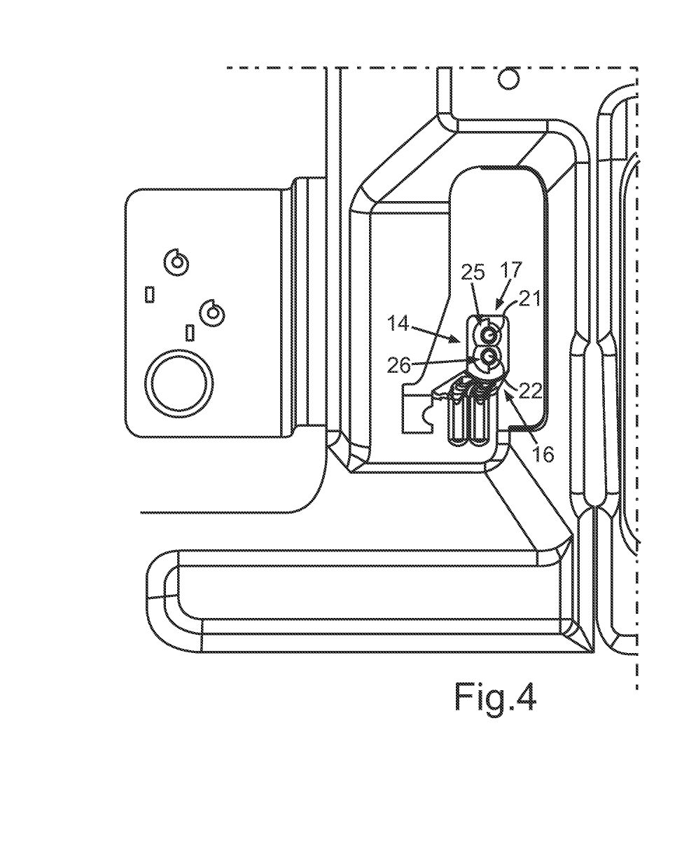

FIG. 4 shows a view from below of the component according to FIGS. 2 and 3; and

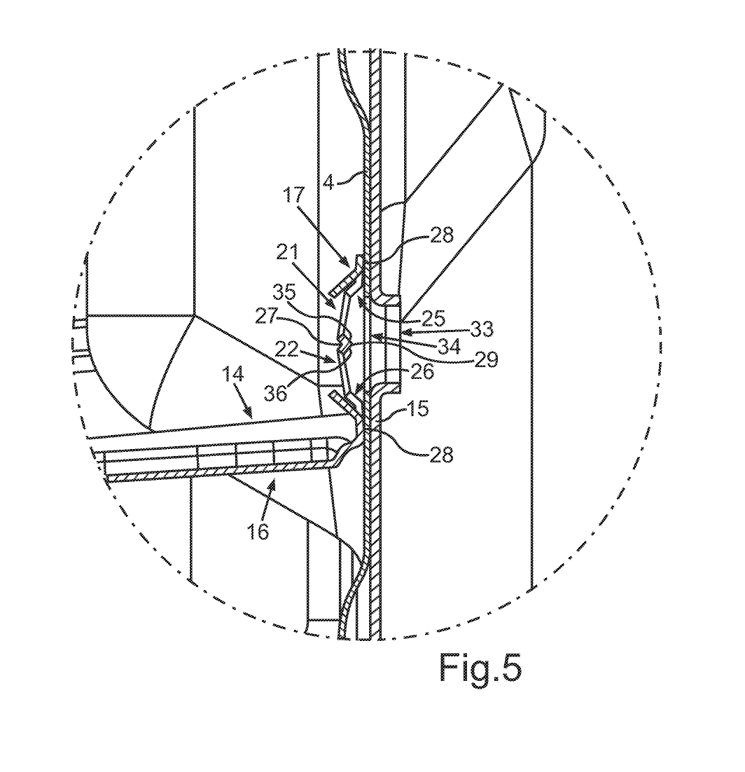

FIG. 5 shows a sectional view of a partial section of the household appliance according to FIG. 1 in the region of a connection between the component and at least one further component part.

In the figures identical elements or those of identical function are shown with identical reference characters.

FIG. 1 shows a schematic perspective view of a household appliance configured as an oven 1. The oven 1 comprises a cooking compartment 2, which is delimited by a muffle 3. The muffle 3 here has side walls (not shown in detail), a base, a top and a rear wall 4.

The muffle 3 is configured with a loading opening at the front, which can be closed off by a door 5.

The oven 1 further comprises an operating apparatus 6, which has a display unit 7 and operating elements 8 and 9. The diagram is merely exemplary both in respect of position and in respect of the number of the display unit 7 and operating elements 8 and 9.

The oven 1 further comprises cooking zones 10, 11, 12 and 13 which are also shown merely by way of example in respect of number and position.

In the region of the muffle rear wall 4 there is provision for a connection between separate components, in this instance a connection being provided between a component 14 (FIG. 2) and a baffle wall 15 (FIG. 5), the muffle rear wall 4 being disposed between the component 14 and the baffle wall 15.

FIG. 2 shows a plan view of the component 14. The component 14, which is configured as a foot, is designed as a single piece and configured for example from sheet metal. The component 14 comprises a support part 16, at the upper end of which a thin-walled sub-element 17 extends at an angle thereto. The thin-walled sub-element 17 is essentially in the manner of a plate and configured as flat on its upper face 18. This thin-walled sub-element 17 comprises a connecting region 19, which is provided for contact with and connection to at least one further component part, for example the rear wall 4 and the baffle wall 15. Configured in the connecting region is a dual receptacle 20, which has a first hole 21 and a second hole 22. The two holes 21 and 22 are disposed adjacent to one another, with center points 23 and 24 of main axes of the holes 21 and 22 being at a distance of 4.5 mm from one another in the exemplary embodiment. Each of the adjacently disposed and separate holes 21 and 22 has a funnel-shaped entrance 25 and 26.

The holes 21 and 22 are configured identically in respect of their diameter and size.

Configured between the holes 21 and 22 is a separating web 27, which runs in a straight line. The separating web 27 at the same time also forms a symmetry position for the dual receptacle 20 in respect of the holes 21 and 22 as well as the funnel-shaped entrances 25 and 26.

By means of the funnel-shaped entrances 25 and 26 the dual receptacle 20 forms as it were a common insertion opening for the two holes 21 and 22. Only the separating web 27 forms a certain separating delimiting wall for the entrances 25 and 26, the separating web being configured as relatively low and not extending to a height position of the upper face 18 of the thin-walled sub-element 17 but being positioned significantly below it. The upper face 18 has an essentially rectangular surface 28 (rounded corners).

FIG. 3 shows a sectional view along the section line III-III in FIG. 2. The component 14 is shown in its embodiment as a connecting foot. It can also be seen in particular that an upper edge 29 of the separating web 27 is at a height level (extension in y direction) that is lower than the upper face 18.

It can also be seen that holes 21 and 22 are configured with their main axes 30 and 31 inclined at an angle to a vertical axis 32. In particular these inclinations of the main axes 30 and 31 are such that they are disposed inclined with an identical angle value, in one instance with the positive angle value and in one instance with the negative angle value, to the vertical axis 32.

The funnel-shaped entrances 25 and 26 of the dual receptacle are shown.

FIG. 4 shows a view from below of the component 14, also showing a more comprehensive view of the secondary components of the oven 1 than in the diagram in FIG. 2.

FIG. 5 shows an enlarged sectional view of the oven 1 in the region of a connection between the component 14, the muffle rear wall 4 and the baffle wall 15. The baffle wall 15 has an opening 33, through which a connecting element in the form of a sheet metal screw (not shown) can be passed, to then pass similarly through an opening 34, which is also a hole in the muffle rear wall 4, to the component 14 and then engage in one of the holes 21 and 22, depending on the respective position tolerance of the cited elements in relation to one another, and be screwed in there. The single self-tapping sheet metal screw therefore only engages in one of the two holes 21 and 22, it being immaterial here which of the two holes 21 and 22 are engaged in to establish the connection.

As can be seen in particular from the diagram in FIGS. 3 and 5, the separating web 27 is configured as a point on its side facing the upper face 18—when viewed in cross section according to FIG. 3—whereby two surfaces dropping obliquely from the upper edge 29 are configured as walls 35 and 36. It also favors guidance of the screw in the direction of the hole 21 or the hole 22, if the screw point tends to extend more in the direction of one of the two holes 21 or 22.

These two walls 35 and 36 can be seen in more detail in particular in FIG. 5.

### LIST OF REFERENCE CHARACTERS

1 Oven
2 Cooking compartment
3 Muffle
4 Rear wall
5 Door
6 Operating apparatus
7 Display unit
8, 9 Operating element
10, 11, 12, 13 Cooking zone
14 Component
15 Baffle wall
16 Support part
17 Sub-element
18 Upper face
19 Connecting region
20 Dual receptacle
21, 22 Hole
23, 24 Center points
25, 26 Entrance
27 Separating web
28 Surface
29 Upper edge
30, 31 Main axis
32 Vertical axis
33, 34 Opening
35, 36 Walls

1-15. (canceled)

16. A component for a household appliance, comprising a thin-walled sub-element having a connecting region configured for connection to at least one further component part and having a funnel-shaped receptacle configured at least as a dual receptacle having at least two adjacent separate holes for passage of a connecting element, said dual receptacle configured to provide funnel-shaped entrances to the holes in one-to-one correspondence.

17. The component of claim 16, wherein at least one of the entrances is configured as a threaded entrance.

18. The component of claim 16, further comprising a separating web configured between the holes.

19. The component of claim 18, wherein the separating web runs in a straight line.

20. The component of claim 18, wherein the separating web is configured with an upper edge at a height level configured below a height level of an upper face of the dual receptacle.

21. The component of claim 18, wherein the separating web forms a symmetry position of the dual receptacle.

22. The component of claim 18, wherein the entrances are separated by the separating web.

23. The component of claim 16, wherein at least one of the holes has a main axis which extends at an inclined at an angle in relation to a vertical axis of the dual receptacle.

24. The component of claim 23, wherein the angle ranges between 15° and 50°.

25. The component of claim 23, wherein the angle ranges, in particular between 20° and 40°.

26. The component of claim 16, wherein the holes are configured at an angle to a vertical axis of the dual receptacle.

27. The component of claim 26, wherein a first one of the holes is configured as inclined with a positive angle value and a second one of the holes is configured as inclined with the negative angle thereto to the vertical axis.

28. The component of claim 16, wherein the holes have center points spaced from one another at a distance of between 3.5 mm and 5 mm.

29. The component of claim 16, wherein the holes have center points spaced from one another at a distance of between 3.8 mm and 4.7 mm.

30. The component of claim 16, further comprising a support part arranged adjacent to the thin-walled sub-element and forming with the thin-walled sub-element an angled foot, said thin-walled sub-element extending in a manner of a plate in a direction at an angle to the support part as a free end of the component.

31. An arrangement for a household appliance, said arrangement comprising:
a component including a thin-walled sub-element having a connecting region configured for connection to at least one further component part and having a funnel-shaped receptacle configured at least as a dual receptacle having at least two adjacent separate holes for passage of a connecting element, said dual receptacle configured to provide funnel-shaped entrances to the holes in one-to-one correspondence;
at least one further separate component part of the household appliance; and
a connecting element configured to connect the component part to the component, said connecting element being disposed in the dual receptacle and only extending through one of the holes.

32. The arrangement of claim 31, wherein the component part is a baffle wall of the household appliance configured as an oven, said baffle wall being screwed to the component.

33. The arrangement of claim 32, further comprising a muffle rear wall, said baffle wall being disposed on one side of the muffle rear wall and screwed to the component disposed on an opposite side of the muffle rear wall.

34. The arrangement of claim 31, wherein the connecting element is a sheet metal screw.

35. The arrangement of claim 34, wherein the sheet metal screw is a self-tapping sheet metal screw.

36. The arrangement of claim 31, wherein at least one of the entrances is configured as a threaded entrance.

37. The arrangement of claim 31, further comprising a separating web configured between the holes.

38. The arrangement of claim 37, wherein the separating web runs in a straight line.

39. The arrangement of claim 37, wherein the separating web is configured with an upper edge at a height level configured below a height level of an upper face of the dual receptacle.

40. The arrangement of claim 37, wherein the separating web forms a symmetry position of the dual receptacle.

41. The arrangement of claim 37, wherein the entrances are separated by the separating web.

42. The arrangement of claim 31, wherein at least one of the holes has a main axis which extends at an inclined at an angle in relation to a vertical axis of the dual receptacle.

43. The arrangement of claim 42, wherein the angle ranges between 15° and 50°.

44. The arrangement of claim 42, wherein the angle ranges, in particular between 20° and 40°.

45. The arrangement of claim 31, wherein the holes are configured at an angle to a vertical axis of the dual receptacle.

46. The arrangement of claim 45, wherein a first one of the holes is configured as inclined with a positive angle value and a second one of the holes is configured as inclined with the negative angle thereto to the vertical axis.

47. The arrangement of claim 31, wherein the holes have center points spaced from one another at a distance of between 3.5 mm and 5 mm.

48. The arrangement of claim 31, wherein the holes have center points spaced from one another at a distance of between 3.8 mm and 4.7 mm.

49. The arrangement of claim 31, further comprising a support part arranged adjacent to the thin-walled sub-element and forming with the thin-walled sub-element an angled foot, said thin-walled sub-element extending in a manner of a plate in a direction at an angle to the support part as a free end of the component.

50. A household appliance, in particular for preparing food, comprising an arrangement which comprises a component including a thin-walled sub-element having a connecting region configured for connection to at least one further component part and having a funnel-shaped receptacle configured at least as a dual receptacle with at least two adjacent separate holes for passage of a connecting element, said dual receptacle configured to provide funnel-shaped entrances to the holes in one-to-one correspondence, at least one further separate component part of the household appliance, and a connecting element configured to connect the component part to the component, said connecting element being disposed in the dual receptacle and only extending through one of the holes.

51. The household appliance of claim 50, wherein the component part is a baffle wall of the household appliance configured as an oven, said baffle wall being screwed to the component.

52. The household appliance of claim 51, wherein the arrangement has a muffle rear wall, said baffle wall being disposed on one side of the muffle rear wall and screwed to the component disposed on an opposite side of the muffle rear wall.

53. The household appliance of claim 50, wherein the connecting element is a sheet metal screw.

54. The household appliance of claim 53, wherein the sheet metal screw is a self-tapping sheet metal screw.
